(19) United States
(12) Patent Application Publication
(10) Pub. No.: US 2026/0105837 A1
(43) Pub. Date: Apr. 16, 2026

(54) Emergency Vehicle Alert System

(71) Applicants: Vince Leonard, Glendora, CA (US); Sharon Leonard, Glendora, CA (US)

(72) Inventors: Vince Leonard, Glendora, CA (US); Sharon Leonard, Glendora, CA (US)

(21) Appl. No.: 19/281,964

(22) Filed: Jul. 28, 2025

Related U.S. Application Data
(60) Provisional application No. 63/705,600, filed on Oct. 10, 2024.

(51) Int. Cl. G08G 1/0965

(52) U.S. Cl. CPC G08G 1/0965

(57) ABSTRACT

An emergency vehicle alert system that comprises software installed within vehicles that audibly alerts drivers of approaching emergency vehicles by announcing when sirens are detected. The software is integrated into a vehicle's main computer system and detects the decibel levels of emergency sirens. Once sirens are detected in an approximately ½ mile radius, the software promptly alerts the driver via the speaker system, allowing them to react in time to let the emergency vehicle pass safely. Visual alerts are also displayed on the dashboard screen to ensure the driver is fully aware of an approaching emergency vehicle. The device can be used on smartphones when using Bluetooth services and live GPS navigation systems for older vehicles that do not have an onboard computer screen.

### CROSS-REFERENCE TO RELATED APPLICATION

The present application claims priority to, and the benefit of, U.S. Provisional Application No. 63/705,600, which was filed on Oct. 10, 2024, and is incorporated herein by reference in its entirety.

### FIELD OF THE INVENTION

The present invention relates generally to the field of emergency vehicle alert devices. More specifically, the present invention relates to software installed in a vehicle's main computer system that reads decibels of an emergency vehicle's siren and notifies the driver of their presence. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in emergency vehicle alert devices. Generally, newer and more modern vehicles are becoming soundproof, and drivers may be unable to hear emergency vehicle sirens from an appropriate distance.

Further, being unaware of an emergency vehicle trying to get by can be dangerous. The driver impedes traffic, and the emergency services vehicle cannot reach their destination quickly. Additionally, emergency vehicles can be involved in traffic accidents when people are not fully aware of an emergency vehicle approaching.

Accordingly, there is a demand for an improved emergency vehicle alert device that features audible and visual alerts on the dashboard to prevent a driver from missing an approaching emergency vehicle. More particularly, there is a demand for an emergency vehicle alert device that improves roadway safety for both pedestrians and emergency vehicles, ensuring the emergency vehicle can reach a victim in a safe and a timely manner.

Therefore, there exists a long felt need in the art for an emergency vehicle alert device that provides users with software installed in a vehicle's main computer system that reads decibels of an emergency vehicle's sirens and notifies the driver of their presence. There is also a long felt need in the art for an emergency vehicle alert device that ensures a driver has ample time to move out of the way and accommodate the emergency vehicle. Further, there is a long felt need in the art for an emergency vehicle alert device that features audible and visual alerts on the dashboard to prevent a driver from missing an approaching emergency vehicle. Moreover, there is a long felt need in the art for a device that improves roadway safety for both pedestrians and emergency vehicles, ensuring the emergency vehicle can reach a victim in safe and timely manner. Further, there is a long felt need in the art for an emergency vehicle alert device that uses Bluetooth services on smart devices to alert drivers. Finally, there is a long felt need in the art for an emergency vehicle alert device that can display on a dashboard screen to alert a driver.

The subject matter disclosed and claimed herein, in one embodiment thereof, comprises an emergency vehicle alert device. The device is software installed within vehicles that audibly alerts drivers of approaching emergency vehicles by announcing when sirens are detected. The software is integrated into a vehicle's main computer system and detects the decibel levels of emergency sirens. Once sirens are detected in an approximately ½ mile radius, the software promptly alerts the driver via the speaker system, allowing them to react in time to let the emergency vehicle pass safely. Visual alerts are also displayed on the dashboard screen to ensure the driver is fully aware of an approaching emergency vehicle. The device can be used on smartphones when using Bluetooth services and live GPS navigation systems for older vehicles that do not have an onboard computer screen. The device can display one, two, or three rotating lights depending on how many emergency vehicles are detected. This makes it possible for emergency vehicles to get to accidents quicker where people need emergency medical attention, ultimately improving roadway safety.

In this manner, the emergency vehicle alert device of the present invention accomplishes all of the forgoing objectives and provides users with software in a vehicle's main computer system that reads decibels of an emergency vehicle's siren. The device can be used on smart devices and with Bluetooth services and live GPS navigation.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an emergency vehicle alert device. The device is software installed within vehicles that audibly alerts drivers of approaching emergency vehicles by announcing when sirens are detected. The software is integrated into a vehicle's main computer system and detects the decibel levels of emergency sirens. The device can also be used on smartphones. This makes it possible for emergency vehicles to get to accidents quicker where people need emergency medical attention, ultimately improving roadway safety.

In one embodiment, the emergency vehicle alert device ensures a driver has ample time to move out of the way and accommodate the emergency vehicle. If drivers are not informed, emergency vehicles can be involved in traffic accidents when people are not fully aware of an emergency vehicle approaching. Thus, the device improves roadway safety for both pedestrian and emergency vehicles, ensuring the emergency vehicles can reach a victim in a safe and timely manner.

In one embodiment, the emergency vehicle alert device is utilized with any suitable vehicle as is known in the art that has the required operating and memory parameters to support the software of the present invention. Typically, any suitable vehicle can be incorporated with the device, as long as the vehicle has an onboard computer (i.e., main computer system). Further, in some embodiments, even older vehicles that do not have an onboard computer can be utilized with the emergency vehicle alert device via utilizing smartphones with Bluetooth services and live GPS navigation.

In one embodiment, the emergency vehicle alert device comprises software installed within vehicles that audibly alerts drivers of approaching emergency vehicles by announcing when sirens are detected. Generally, the software is integrated into a vehicle's main computer system and detects the decibel levels of emergency sirens. Typically, the software is installed at the point of manufacture of the vehicle, but can be also installed aftermarket, as needed, depending on the type of vehicle which utilizes the device.

In one embodiment, once sirens from emergency vehicles are detected in the nearby vicinity, via the installed software, the driver is alerted. Typically, emergency vehicles are detected within an approximately ¼-½ mile radius of the vehicle or any other suitable distance. In one embodiment, the driver can program the mile radius the emergency vehicles need to be in, to create an alert.

In one embodiment, the software is programmed to read the decibel level of the emergency vehicle's sirens to determine when to alert a user/driver of the vehicle of the approaching emergency vehicle. In this embodiment, the vehicle's computer communicates with a microphone within the vehicle, to detect the decibel level of the sirens. Users can also program the desired decibel level the siren has to make, to create the alert.

In one embodiment, the software can be programmed to send an alert or other electronic notification when an emergency vehicle is detected. Additionally, the software can be programmed to send a visual alert and/or an audible alert to a user when the emergency vehicle has been detected. Thus, once the emergency vehicle has been detected, the software promptly alerts the driver via the vehicle's speaker system, allowing them to react in time to let the emergency vehicle pass safely.

In one embodiment, the device also provides visual alerts to a user/driver of the vehicle of the approaching emergency vehicles. For example, the visual alerts are displayed on the vehicle's dashboard screen to ensure the driver is fully aware of an approaching emergency vehicle. The device can display one, two, or three rotating lights (or other suitable icons or symbols) on the dashboard screen, depending on how many emergency vehicles are detected within the vicinity. This makes it possible for emergency vehicles to get to accidents quicker where people need emergency medical attention, ultimately improving roadway safety.

In one embodiment, the device can be used on smartphones when using Bluetooth services and live GPS navigation systems for older vehicles that do not have an onboard computer screen. Generally, GPS is embedded in the computer or tablet, etc., as it is in a smartphone, etc., and is used in navigation applications in these devices as well as in vehicles. In this embodiment, the mobile device or smartphone may be a cellular telephone, or any other device that may have wireless communication capabilities and may be connected to the internet. The mobile or smart device may perform any type of wireless communication, including, but not limited to, WIFI, BLUETOOTH, RFID, NFC, etc. The vehicle further includes a wireless communication module and additional sensors which would allow the vehicle to pair with a mobile application on a mobile or smart device. Once paired, a user could detect approaching emergency vehicles via the mobile application which would display a map-like view of the approaching emergency vehicles. For example, the smartphone or other device can display one, two, or three rotating lights on the phone screen, depending on how many emergency vehicles are detected within the vicinity or can sound an audible alert. Thus, alerting the driver/user and making it possible for emergency vehicles to get to accidents quicker where people need emergency medical attention, ultimately improving roadway safety.

In yet another embodiment, the emergency vehicle alert device comprises a plurality of indicia.

In yet another embodiment, a method of alerting drivers of emergency vehicles in the vicinity is disclosed. The method includes the steps of providing an emergency vehicle alert device comprising software installed within vehicles'main computer system. The method also comprises detecting the decibel levels of emergency sirens within an ½ mile radius. Further, the method comprises alerting a driver on the dashboard screen of the approaching emergency vehicle. The method also comprises emitting an audible alert. Finally, the method comprises using smartphones with Bluetooth services and live GPS navigation for older vehicles to alert drivers of approaching emergency vehicles.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the emergency vehicle alert device of the present invention in accordance with the disclosed architecture;

FIG. 2 illustrates a perspective view of one embodiment of the emergency vehicle alert device of the present invention showing the alerts on a user's dashboard in accordance with the disclosed architecture;

FIGS. 3A-B illustrate a perspective view of one embodiment of the emergency vehicle alert device of the present invention showing the device in use in accordance with the disclosed architecture; and

FIG. 4 illustrates a flowchart showing the method of alerting drivers of emergency vehicles in the vicinity in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for an emergency vehicle alert device that provides users with software installed in a vehicle's main computer system that reads decibels of an emergency vehicle's sirens and notifies the driver of their presence. There is also a long felt need in the art for an emergency vehicle alert device that ensures a driver has ample time to move out of the way and accommodate the emergency vehicle. Further, there is a long felt need in the art for an emergency vehicle alert device that features audible and visual alerts on the dashboard to prevent a driver from missing an approaching emergency vehicle. Moreover, there is a long felt need in the art for a device that improves roadway safety for both pedestrians and emergency vehicles, ensuring the emergency vehicle can reach a victim in safe and timely manner. Further, there is a long felt need in the art for an emergency vehicle alert device that uses Bluetooth services on smart devices to alert drivers. Finally, there is a long felt need in the art for an emergency vehicle alert device that can display on a dashboard screen to alert a driver.

The present invention, in one exemplary embodiment, is a novel emergency vehicle alert device. The device is software installed within vehicles that audibly alerts drivers of approaching emergency vehicles by announcing when sirens are detected. The software is integrated into a vehicle's main computer system and detects the decibel levels of emergency sirens. Once sirens are detected in an approximately ½ mile radius, the software promptly alerts the driver via the speaker system, allowing them to react in time to let the emergency vehicle pass safely. Visual alerts are also displayed on the dashboard screen to ensure the driver is fully aware of an approaching emergency vehicle. Audio alerts can be an audible sound, a recorded voice, etc. The device can be used on smartphones when using Bluetooth services and live GPS navigation systems for older vehicles that do not have an onboard computer screen. The present invention also includes a novel method of alerting drivers of emergency vehicles in the vicinity. The method includes the steps of providing an emergency vehicle alert device comprising software installed within vehicles'main computer system. The method also comprises detecting the decibel levels of emergency sirens within an ½ mile radius. Further, the method comprises alerting a driver on the dashboard screen of the approaching emergency vehicle. The method also comprises emitting an audible alert. Finally, the method comprises using smartphones with Bluetooth services and live GPS navigation for older vehicles to alert drivers of approaching emergency vehicles.

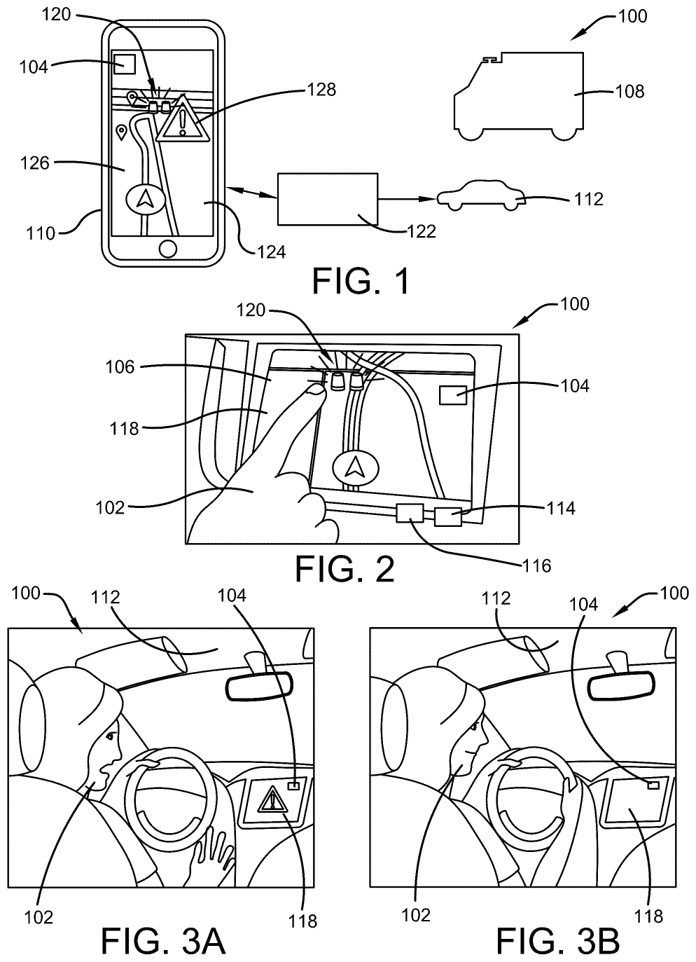

Referring initially to the drawings, FIG. 1 illustrates a perspective view of one embodiment of the emergency vehicle alert device 100 of the present invention. In the present embodiment, the emergency vehicle alert device 100 is an improved emergency vehicle alert device 100 that provides users 102 with software 104 installed in a vehicle's main computer system 106. Specifically, the emergency vehicle alert device 100 audibly alerts drivers/users 102 of approaching emergency vehicles 108 by announcing when sirens are detected. The software 104 detects the decibel levels of emergency sirens. The device 100 can also be used on smartphones 110. This makes it possible for emergency vehicles 108 to get to accidents quicker where people need emergency medical attention, ultimately improving roadway safety.

Generally, the emergency vehicle alert device 100 ensures a driver 102 has ample time to move out of the way and accommodate the emergency vehicle 108. If drivers 102 are not informed, emergency vehicles 108 can be involved in traffic accidents when people are not fully aware of an emergency vehicle 108 approaching. Thus, the device 100 improves roadway safety for both pedestrian and emergency vehicles, ensuring the emergency vehicles 108 can reach a victim in a safe and timely manner.

Further, the emergency vehicle alert device 100 is utilized with any suitable vehicle 112 as is known in the art that has the required operating and memory parameters to support the software 104 of the present invention. Typically, any suitable vehicle 112 can be incorporated with the device 100, as long as the vehicle 112 has an onboard computer (i.e., main computer system 106). Further, in some embodiments, even older vehicles 112 that do not have an onboard computer 106 can be utilized with the emergency vehicle alert device 100 via utilizing smartphones 110 with Bluetooth services and live GPS navigation.

Additionally, the emergency vehicle alert device 100 comprises software 104 installed within vehicles 112 that audibly alerts drivers 102 of approaching emergency vehicles 108 by announcing when sirens are detected. Generally, the software 104 is integrated into a vehicle's main computer system 106 and detects the decibel levels of emergency sirens. Typically, the software 104 is installed at the point of manufacture of the vehicle 112, but can be also installed aftermarket, as needed, depending on the type of vehicle 112 which utilizes the device 100.

Furthermore, once sirens from emergency vehicles 108 are detected in the nearby vicinity, via the installed software 104, the driver 102 is alerted. Typically, emergency vehicles 108 are detected within an approximately ¼-½ mile radius of the vehicle 112 or any other suitable distance. In one embodiment, the driver 102 can program the mile radius the emergency vehicles 108 need to be in, to create an alert.

Additionally, the software 104 is programmed to read the decibel level of the emergency vehicle's sirens to determine when to alert a user/driver 102 of the vehicle 112 of the approaching emergency vehicle 108. In this embodiment, the vehicle's computer 106 communicates with a microphone 114 within the vehicle 112, to detect the decibel level of the sirens. Users 102 can also program the desired decibel level the siren has to make, to create the alert.

In one embodiment, the device 100 can be used on smartphones 110 when using Bluetooth services and live GPS navigation systems for older vehicles that do not have an onboard computer screen. Generally, GPS is embedded in the computer or tablet, etc., as it is in a smartphone 110, etc., and is used in navigation applications in these devices as well as in vehicles 112. In this embodiment, the mobile device or smartphone 110 may be a cellular telephone, or any other device that may have wireless communication capabilities and may be connected to the internet. The mobile or smart device 110 may perform any type of wireless communication, including, but not limited to, WIFI, BLUETOOTH, RFID, NFC, etc. The vehicle 112 further includes a wireless communication module 122 and additional sensors which would allow the vehicle 112 to pair with a mobile application 124 on a mobile or smart device 110. Once paired, a user 102 could detect approaching emergency vehicles 108 via the mobile application 124 which would display a map-like view of the approaching emergency vehicles 108. For example, the smartphone 110 or other device can display one, two, or three rotating lights 120 on the phone screen 126, depending on how many emergency vehicles 108 are detected within the vicinity or can sound an audible alert. Thus, alerting the driver/user 102 and making it possible for emergency vehicles 108 to get to accidents quicker where people need emergency medical attention, ultimately improving roadway safety.

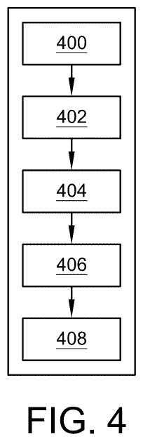

As shown in FIGS. 2 and 3A-B, the software 104 can be programmed to send an alert or other electronic notification when an emergency vehicle 108 is detected. Additionally, the software 104 can be programmed to send a visual alert and/or an audible alert to a user 102 when the emergency vehicle 108 has been detected. Thus, once the emergency vehicle 108 has been detected, the software 104 promptly alerts the driver 102 via the vehicle's speaker system 116, allowing them to react in time to let the emergency vehicle 108 pass safely.

Further, the device 100 also provides visual alerts to a user/driver 102 of the vehicle 112 of the approaching emergency vehicles 108. For example, the visual alerts are displayed on the vehicle's dashboard screen 118 to ensure the driver 102 is fully aware of an approaching emergency vehicle 108. The device 100 can display one, two, or three rotating lights 120 (or other suitable icons or symbols) on the dashboard screen 118, depending on how many emergency vehicles 108 are detected within the vicinity. This makes it possible for emergency vehicles 108 to get to accidents quicker where people need emergency medical attention, ultimately improving roadway safety.

In yet another embodiment, the emergency vehicle alert device comprises a plurality of indicia 128. The dashboard 118 of the vehicle 112 may include advertising, a trademark, or other letters, designs, or characters, printed, painted, stamped, or integrated into the dashboard 118, or any other indicia 128 as is known in the art. Specifically, any suitable indicia 128 as is known in the art can be included, such as but not limited to, patterns, logos, emblems, images, symbols, designs, letters, words, characters, animals, advertisements, brands, etc., that may or may not be vehicle, emergency vehicle, or brand related.

FIG. 4 illustrates a flowchart of the method of alerting drivers of emergency vehicles in the vicinity. The method includes the steps of at 400, providing an emergency vehicle alert device comprising software installed within vehicles'main computer system. The method also comprises at 402, detecting the decibel levels of emergency sirens within an ½ mile radius. Further, the method comprises at 404, alerting a driver on the dashboard screen of the approaching emergency vehicle. The method also comprises at 406, emitting an audible alert. Finally, the method comprises at 408, using smartphones with Bluetooth services and live GPS navigation for older vehicles to alert drivers of approaching emergency vehicles.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “emergency vehicle alert device”, “emergency vehicle device”, “alert device”, and “device” are interchangeable and refer to the emergency vehicle alert device 100 of the present invention.

Notwithstanding the forgoing, the emergency vehicle alert device 100 of the present invention can be of any suitable size and configuration as is known in the art without affecting the overall concept of the invention, provided that it accomplishes the above stated objectives. One of ordinary skill in the art will appreciate that the emergency vehicle alert device 100 as shown in FIGS. 1-4 is for illustrative purposes only, and that many other sizes and shapes of the emergency vehicle alert device 100 are well within the scope of the present disclosure. Although the dimensions of the emergency vehicle alert device 100 are important design parameters for user convenience, the emergency vehicle alert device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An emergency vehicle alert system comprising:
a software installed in a main computer system of a vehicle, wherein the software is programmed to alert a user of an approaching emergency vehicle, and further wherein the software detects a decibel level of an emergency siren.

2. The emergency vehicle alert system of claim 1, wherein the emergency vehicle alert device is utilized with any suitable vehicle that has required operating and memory parameters to support the software.

3. The emergency vehicle alert system of claim 2, wherein the software is installed at a point of manufacture of the vehicle.

4. The emergency vehicle alert system of claim 3, wherein the approaching emergency vehicle is detected within an approximately ¼-½ mile radius of the vehicle.

5. The emergency vehicle alert system of claim 3, wherein the user can program mile radius the approaching emergency vehicle needs to be in to create an alert.

6. The emergency vehicle alert system of claim 3, wherein the software is configured to communicate with a computer in the vehicle and a microphone within the vehicle to detect the decibel level of the emergency siren.

7. The emergency vehicle alert system of claim 6, wherein the user can also program a desired decibel level that the emergency siren has to make to create an alert.

8. The emergency vehicle alert system of claim 7, wherein the software can be used on a smartphone with Bluetooth services and in GPS navigation systems.

9. The emergency vehicle alert system of claim 8, wherein the vehicle comprises a wireless communication module and additional sensors that would allow the vehicle to pair with a mobile application on the smartphone.

10. The emergency vehicle alert system of claim 9, wherein the software is programmed to send the alert when the approaching emergency vehicle is detected.

11. The emergency vehicle alert system of claim 10, wherein the software is programmed to send a visual alert or an audible alert to a user when the emergency vehicle has been detected.

12. An emergency vehicle alert system comprising:
a vehicle having a computer and a microphone;
a software installed in a main computer system of the vehicle;
wherein an emergency vehicle is detected within an approximately ¼-½ mile radius of the vehicle;
wherein the computer communicates with the microphone within the vehicle to detect a decibel level of an emergency vehicle siren;
wherein the software is programmed to send an alert when the emergency vehicle is detected; and
further wherein the software is programmed to send a visual alert or an audible alert to a user when the emergency vehicle has been detected.

13. The emergency vehicle alert system of claim 12, wherein the software is configured to be installed on a smartphone.

14. The emergency vehicle alert system of claim 13, wherein the vehicle further comprises a wireless communication module and a plurality of sensors which allow the vehicle to pair with a mobile application on the smartphone.

15. The emergency vehicle alert system of claim 12, wherein the visual alert is displayed on a dashboard screen of the vehicle to ensure the user is fully aware of the emergency vehicle.

16. The emergency vehicle alert system of claim 15, wherein one, two, or three rotating lights are displayed on the dashboard screen.

17. The emergency vehicle alert system of claim 12, wherein the audio alert is an audible sound.

18. The emergency vehicle alert system of claim 12 further comprising a plurality of indicia.

19. The emergency vehicle alert system of claim 12, wherein the audio alert is a recorded voice.

20. A method of alerting a driver of an approaching emergency vehicle, the method comprising the following steps:
providing an emergency vehicle alert system comprising a software installed within a main computer system of a vehicle;
detecting a decibel level of an emergency siren of an approaching emergency vehicle within a user specified radius;
alerting the driver of the approaching emergency vehicle on the dashboard screen of the vehicle or via an audible alert.
